(19) United States
(12) Patent Application Publication
(10) Pub. No.: US 2009/0066565 A1
(43) Pub. Date: Mar. 12, 2009

(54) GNSS TERMINALS AUTOMATICALLY RETRIEVING AIDING DATA AND AIDING DATA SYSTEMS

(75) Inventors: Chien-Liang Tsai, Taipei County (TW); Yeou-Jyh Tsai, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/853,056

(22) Filed: Sep. 11, 2007

(51) Int. Cl. G01S 5/14

(52) U.S. Cl. 342/357.03; 342/357.15

(57) ABSTRACT

The invention provides an aiding data collecting method for a Global Navigation Satellite System (GNSS) terminal connected to an aiding data server through a wireless connection. Availability of an aiding data is first queried about. Whether the aiding data is in the GNSS terminal is then checked according to the response of the query. An aiding data request is then sent to the aiding data server. An aiding data sent by the aiding data server is then parsed in response to the aiding data request. Finally, the collected aiding data is sent to the GNSS terminal for acquiring and/or tracking satellite signal from at least one GNSS satellite.

### BACKGROUND OF THE INVENTION

1. Field of the Invention

The invention relates to Global Navigation Satellite Systems (GNSS), and more particularly to aiding data systems of GNSS.

2. Description of the Related Art

Global Navigation Satellite System (GNSS) is the standard generic term for satellite navigation systems that provide autonomous geo-spatial positioning with global coverage. A GNSS allows electronic receivers to determine their location (longitude, latitude, and altitude) to within a few meters using radio signals transmitted from satellites. Current GNSS include Global Positioning System (GPS) of the United States, GLObal NAvigation Satellite System (GLONASS) of Russia, Galileo positioning system of European Union, and Beidou navigation system of China.

Time to first fix (TTFF), the time from turning on a GNSS receiver until its position is determined, is one of key performance measures of a GNSS receiver. The shorter the TTFF of a GNSS receiver, the better the user's experience. The TTFF of a GNSS receiver is determined by a few factors including signal environment of the GNSS receiver, Dilution of Precision (DOP) values of satellites tracked by the GNSS receiver, and availability of orbital parameters and health data of the satellites. In a poor signal environment, tracking satellites with low DOP values and aiding data with orbital parameters can improve positioning calculation of the GNSS receiver. Dilution of Precision (DOP) is a GNSS term used in geometries engineering to describe the geometric strength of satellite configuration on GNSS positioning accuracy. When visible satellites are close together in the sky, the geometry is said to be weak and the DOP value is high; when far apart, the geometry is strong and the DOP value is low.

Because health data of GNSS satellites changes with time, aiding data servers are therefore brought up to provide GNSS receivers with aiding data comprising latest satellite orbital parameters and health data through wireless network link, which can be an efficient communication channel in poor GNSS signal environment.

### BRIEF SUMMARY OF THE INVENTION

The invention provides a Global Navigation Satellite System (GNSS) terminal. In one embodiment, the GNSS terminal is connected to an aiding data server through a wireless connection and comprises an aiding data collector and a GNSS receiver. The aiding data collector sends an aiding data request to the aiding data server, and parses aiding data sent by the aiding data server in response to the aiding data request. The GNSS receiver acquires and/or tracks signal from at least one GNSS satellite according to the aiding data.

The invention also provides an aiding data collecting method for a Global Navigation Satellite System (GNSS) terminal connected to an aiding data server through a wireless connection. Availability of an aiding data is first queried about. Whether the aiding data is in the GNSS terminal is then checked according to the response of the query. An aiding data request is then sent to the aiding data server. An aiding data sent by the aiding data server is then parsed in response to the aiding data request. Finally, the collected aiding data is sent to the GNSS terminal for acquiring and/or tracking satellite signal from at least one GNSS satellite.

The invention provides an aiding data system subordinate to a Global Navigation Satellite System (GNSS). In an embodiment, the aiding data system comprises an aiding data server and a GNSS terminal. The aiding data server parses an aiding data request received from the GNSS terminal to generate aiding data comprising orbital parameters and health information of a predetermined number of GNSS satellites visible to the GNSS terminal, sorts the aiding data according to dilution of precision (DOP) values of the visible GNSS satellites, and sends the aiding data to the GNSS terminal in response to the aiding data request. The GNSS terminal sends the aiding data request to the aiding data server, parses the aiding data sent by the aiding data server, and tracks GNSS satellites according to the aiding data to generate a position of the GNSS terminal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a GNSS system comprising an aiding data system according to the invention;

FIG. 2 is a block diagram of a GNSS terminal according to the invention;

FIG. 3 is a block diagram of an aiding data server according to the invention;

FIG. 4 shows an aiding data server maintaining database storage of information of GNSS satellites to generate aiding data;

FIG. 5 is a flowchart of operations of an aiding data collector of a GNSS terminal according to the invention;

FIG. 6 is a flowchart of operations of an aiding data generator of an aiding data server according to the invention; and

FIG. 7 shows an association table storing cell-IDs or network addresses of multiple base stations and corresponding geographical locations.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

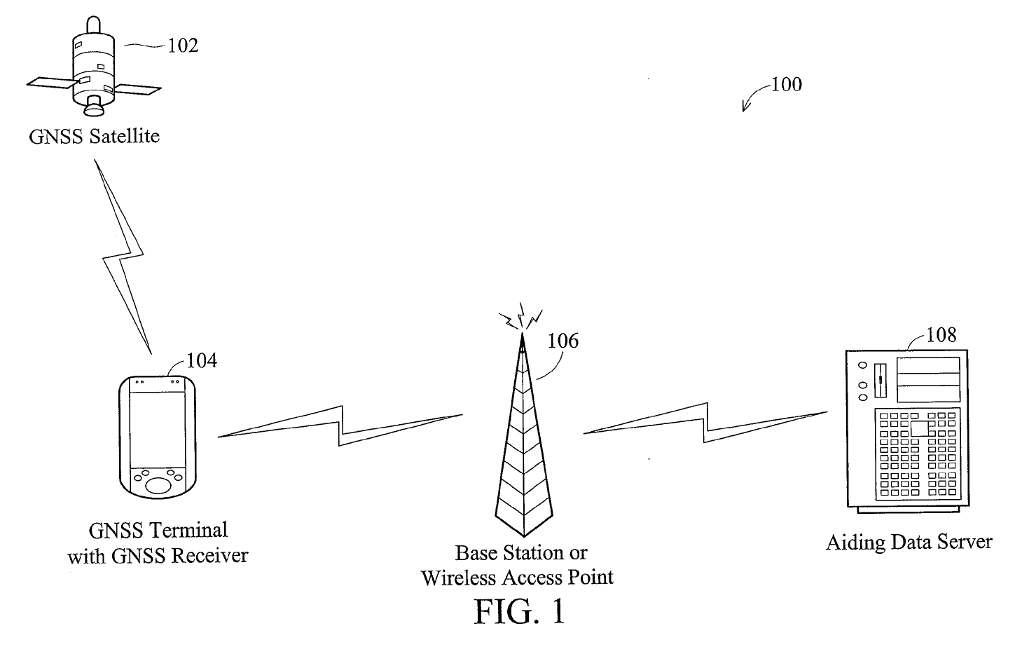

FIG. 1 is a GNSS system 100 comprising an aiding data system according to the invention. The GNSS system 100 comprises a GNSS satellite 102, a GNSS terminal 104, a base station or wireless access point 106, and an aiding data server 108. The GNSS terminal 104 can build a connection to the aiding data server 108 through the base station or wireless access point 106, and the aiding data server 108 provides the GNSS terminal 104 with aiding data through the wireless connection to facilitate positioning of the GNSS terminal 104. The GNSS terminal 104 then tracks GNSS satellites 102 by the GNSS receiver thereof according to the aiding data provided by the aiding data server 108, and generates a position of the GNSS terminal according to the GNSS satellites 102. The GNSS receiver can reduce power consumption on searching for satellites and decoding navigation messages from the satellites. With orbital parameters within the aiding data, the GNSS receiver is able to know position of satellites without decoding the message from satellites thus the TTFF is reduced and user's experience of the GNSS terminal is improved.

The aiding data provided by the aiding data server 108 comprises orbital parameters and health data of GNSS satellites. While many GNSS satellites are around the earth, GNSS terminal 104 has access to only a few. GNSS satellites with estimated elevation angles smaller than approximately −10 degrees are classified as invisible satellites, being useless for positioning of the GNSS terminal 104 with some uncertainty of initial position. Thus, orbital parameters and health data of invisible GNSS satellites can be excluded from the aiding data to reduce network bandwidth required for transmission.

Because visible GNSS satellites with better geometry distribution improve precision and efficiency of positioning, the orbital parameters and health data of visible GNSS satellites are sorted and transmitted in an order so that the DOP value is as small as possible. In an embodiment, aiding data of selected six visible GNSS satellites is transmitted, with the transmit order is determined by the DOP of the first 3, 4, 5, and 6 selected satellites orbital data. A list of invisible satellites is then transmitted to reduce search activities of the GNSS receiver, and aiding data about other visible satellites is finally transmitted. The aiding data may also comprise current time, a rough position of the GNSS terminal, or differential GPS correction data if network bandwidth is allowable. The aiding data may further comprise an association table of network addresses and geographic locations of base stations.

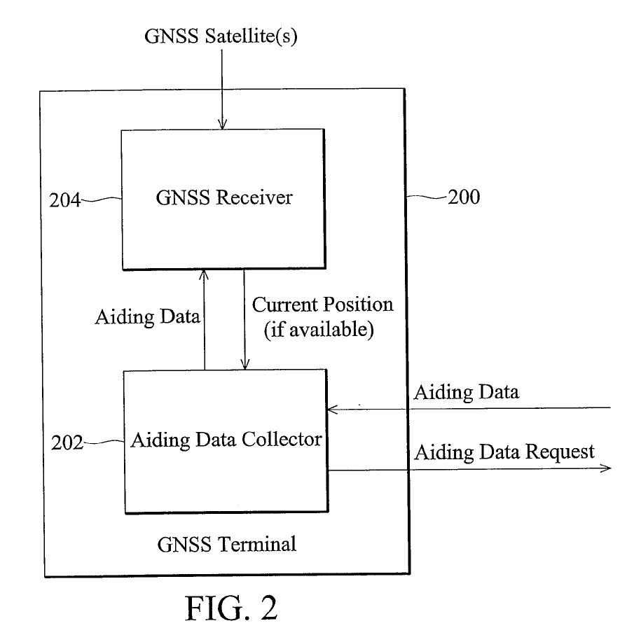

FIG. 2 is a block diagram of a GNSS terminal 200 according to the invention. The GNSS terminal 200 comprises an aiding data collector 202 and a GNSS receiver 204. The aiding data may be automatically sent by an aiding data server if the aiding data server detects changes of satellite health, and the aiding data collector 202 updates the corresponding satellite health data. When the GNSS terminal 200 restarts, changes a base station or wireless access point thereof, existing aiding data expires, or predetermined timeout for checking whether invisible satellites rises to become visible satellites occurs, the GNSS terminal 200 needs to update aiding data for positioning. Thus, the aiding data collector 202 sends an aiding data request to an aiding data server for latest aiding data.

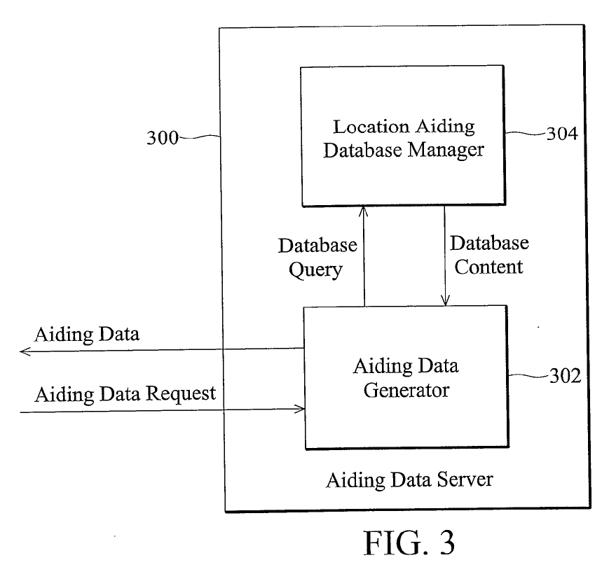

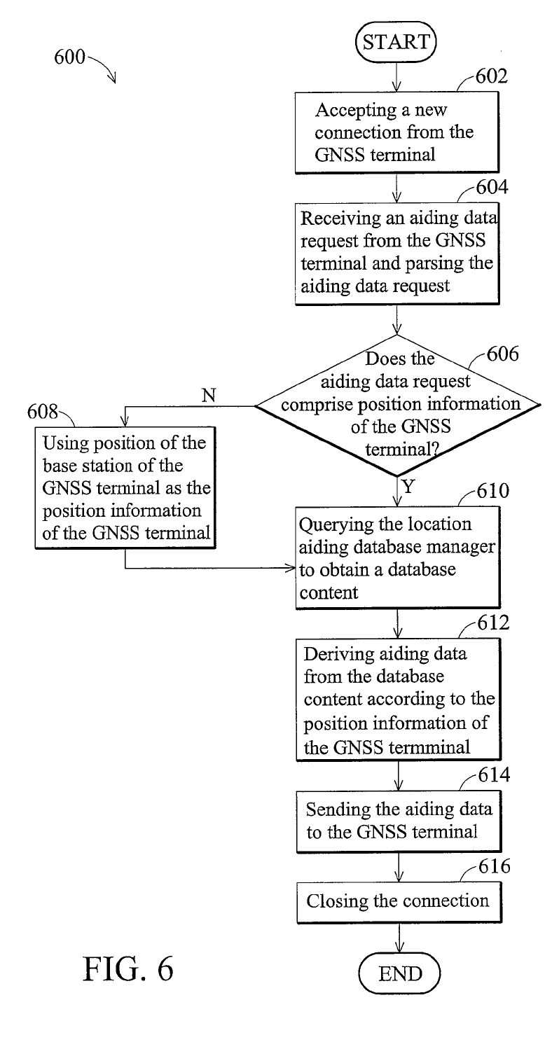

When an aiding data server receives the aiding data request, it transmits aiding data to the GNSS terminal in response to the aiding data request. FIG. 3 is a block diagram of an aiding data server 300 according to the invention. The aiding data server 300 may be settled in a base station or coupled to a backbone network and comprises an aiding data generator 302 and a location aiding database manager 304. The location aiding database manager 304 continuously gathers and updates latest information about GNSS satellites, such as health data and orbital parameters of the satellites. When the aiding data generator 302 receives the aiding data request from the GNSS terminal 200, the aiding data generator 302 queries the location aiding database manager 304 to obtain aiding data from the database. The aiding data generator 302 then derives aiding data from the database content, sorting the aiding data according to dilution of precision (DOP) values of visible GNSS satellites, and transmits the aiding data to the GNSS terminal 100. The operation of aiding data generator 302 is further explained with FIG. 6.

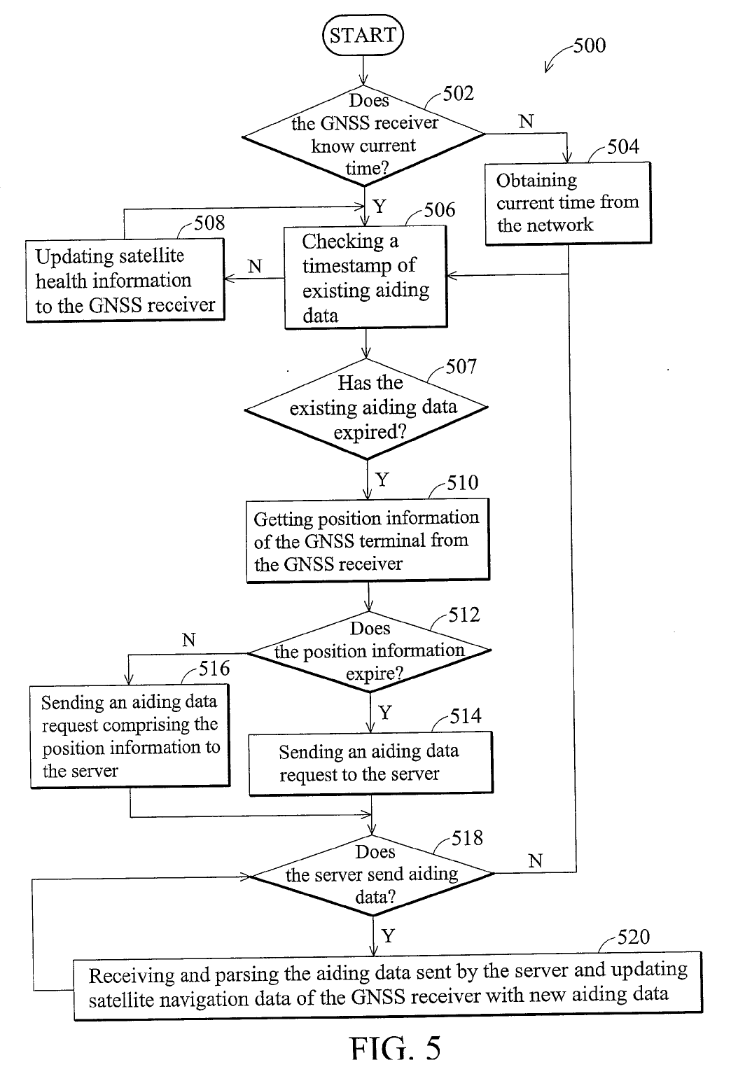

Referring again to FIG. 2, when the aiding data collector 202 receives the aiding data from the aiding data server 300, the aiding data collector 202 parses the aiding data and updates information stored in the GNSS receiver 204 with the received aiding data. The GNSS receiver 204 can then track GNSS satellites with smaller DOP values according to the received orbital parameters and health data with higher accuracy and quickly generate a position of the GNSS terminal 200. The operation of the aiding data collector 202 is further explained with FIG. 5.

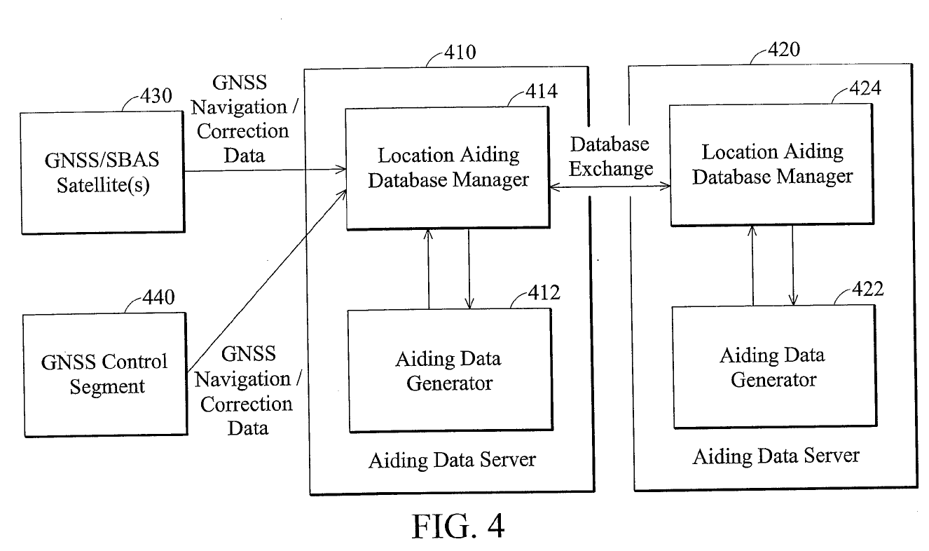

FIG. 4 shows an aiding data server 410 maintaining database storage of information of GNSS satellites to generate aiding data. The aiding data server 410 may decode messages from GNSS satellites or Satellite-Based-Augmentation-System (SBAS) satellites 430 to obtain aiding information. The aiding data server 410 may also obtain navigation message or correction data from GNSS control segments 440, SBAS control segments, or International-GNSS-Service (IGS) network to update the database storing information about GNSS satellites, especially orbital parameters. Because aiding data servers may connect to each other, the aiding data server 410 can also exchange database information with other aiding data servers, such as the aiding data server 420 shown in FIG. 4. Thus, the satellite information stored in the location aiding database manager of an aiding data server is always fresh and accurate.

FIG. 5 is a flowchart 500 of operations of an aiding data collector of a GNSS terminal according to the invention. First, the aiding data collector determines whether a GNSS receiver of the GNSS terminal knows the current time in step 502. If not, the aiding data collector obtains current time from a network in step 504. The aiding data collector then determines whether the GNSS terminal needs to request new aiding data from the aiding data server. The aiding data collector first checks the timestamp of existing aiding data previously received from the aiding data server in advance in step 506 to determine whether to send an aiding data request to the aiding data server. If existing aiding data has not expired in step 507, the aiding data collector does not send an aiding data request and waits for the next event for sending requests. During the waiting, aiding data collector updates satellite health information to the GNSS receiver in step 508 if the satellite health data from the aiding data server is available. If existing data has expired in step 507, the aiding data collector determines to send an aiding data request to the aiding data server to update satellite navigation data of the GNSS receiver with new aiding data The GNSS receiver can determine whether to update its satellite navigation data from the aiding data collector based on the timestamp or satellite health.

Because the aiding data server requires a rough position of the GNSS terminal to sort and filter aiding data from the viewpoint of the GNSS terminal, the aiding data collector must provide rough position information of the GNSS terminal for the aiding data server through the aiding data request. Thus, the aiding data collector gets position information about the GNSS terminal from the GNSS receiver in step 510. The position information, however, may have expired (for example, exceeding 60 minutes) and is thus not useful to the aiding data server because the GNSS terminal may have moved a long distance, which causes bad estimation of elevation and azimuth angles of satellites. If so, the aiding data collector directly sends an aiding data request without position information to the aiding data server in step 514. Otherwise, if the position information obtained from the GNSS receiver has not expired in step 512, the aiding data collector sends an aiding data request comprising the position information to the aiding data server in step 516. After receiving the aiding data request, the aiding data server responds to the aiding data request with aiding data in step 518, and the aiding data collector receives and parses the aiding data received from the aiding data server in step 520. The aiding data collector then updates satellite navigation data of the GNSS receiver with new aiding data in step 520.

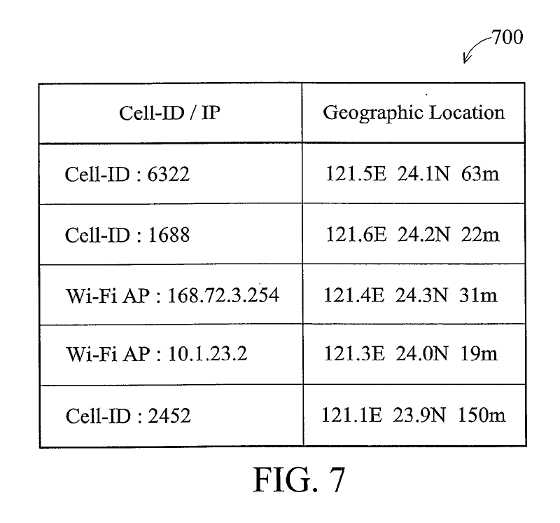

FIG. 6 is a flowchart 600 of operations of an aiding data generator of an aiding data server according to the invention. The aiding data server first accepts a new connection from a GNSS terminal in step 602, and the aiding data generator receives an aiding data request from the GNSS terminal through the connection and parses the aiding data request in step 604. The aiding data generator then determines whether the received aiding data request comprises position information of the GNSS terminal in step 606. If not, the aiding data generator uses the position of a base station of the GNSS terminal as a rough position of the GNSS terminal in step 608, since the base station must be proximate to the GNSS terminal. To obtain the position of the base station, the aiding data generator searches a table for the position with the cell-ID or network address of the base station. FIG. 7 shows an association table 700 storing cell-IDs or network addresses of multiple base stations and corresponding geographical locations (longitude, latitude, and altitude).

The aiding data generator then queries a location aiding database manager of the aiding data server to obtain database content about satellite information in step 610. The aiding data generator then derives aiding data from the database content in step 612 according to the position information of the GNSS terminal. The aiding data generator first derives elevation angles and moving directions of GNSS satellites from the satellite orbit data recorded in the database content from the viewpoint of the GNSS terminal according to the position information. The aiding data generator then sorts satellite information of the database content according to elevation angles and moving directions (rising or falling), optimizing DOP value of the first few selected satellites.

The aiding data generator then sends aiding data to the GNSS terminal in step 614. The aiding data generator first sends the satellite information about 6 visible GNSS satellites with reduced DOP values to the GNSS terminal as the aiding data. GNSS satellites with elevation angles smaller than approximately −10 degrees are classified as invisible satellites, and the aiding data server only sends a list of invisible satellites as aiding data without transmitting complete satellite information. Thus, the network bandwidth required for aiding data transmission is reduced. The power of the GNSS receiver required for decoding the navigation message is also reduced. In addition, unnecessary satellite search activities are eliminated to conserve power. The satellite information about other remnant visible satellites is finally transmitted as aiding data. Finally, after the aiding data generator has transmitted all aiding data, the aiding data server closes the connection in step 616. The implementation of logical network link between the GNSS terminal and the aiding data server may be connection-oriented or connectionless.

Although the aiding data server often passively replies aiding data to GNSS terminals in response to aiding data requests of the GNSS terminals, the aiding data server can automatically pushes aiding data comprising satellite health data to the GNSS terminals if the satellite health data has been changed. Besides, in addition to connecting to an aiding data server through wireless network link, a GNSS terminal can connect to the aiding data server through a wired network link, such as through a USB cable connected to a computer. In the situation, the GNSS terminal can obtain aiding data comprising an association table of cell-ID or network addresses of neighboring base stations and their geographic locations from the aiding data server or from a networked device connected to the aiding data server.

The invention provides an aiding data system comprising a GNSS terminal and an aiding data server. The aiding data server provides the GNSS terminal with aiding data comprising latest satellite information, such as orbital parameters and health data. The selection and order of satellite information is targeted on minimizing DOP values of the first few selected visible satellites, and the aiding data only comprises complete information about a predetermined number (four to six) of selected visible satellites. The GNSS terminal can then try to track the satellites according to the aiding data to generate a position thereof, reducing the TTFF. In addition, the time and bandwidth required for transmitting the aiding data are reduced, and power consumption required for the GNSS terminal to search satellites and decode the navigation message are also reduced to improve the performance of the GNSS terminal.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A Global Navigation Satellite System (GNSS) terminal, connected to an aiding data server through a wireless connection, comprising:
an aiding data collector for sending an aiding data request to the aiding data server, and parsing aiding data sent by the aiding data server in response to the aiding data request; and
a GNSS receiver, coupled to the aiding data collector, for acquiring and/or tracking signal from at least one GNSS satellite according to the aiding data.

2. The GNSS terminal as claimed in claim 1, wherein the aiding data comprises orbital parameters and health information of a predetermined number of GNSS satellites visible to the GNSS terminal, and the aiding data is sorted according to dilution of precision (DOP) values of the visible GNSS satellites.

3. The GNSS terminal as claimed in claim 2, wherein the aiding data further comprises a list of GNSS satellites invisible to the GNSS terminal, wherein estimated elevation angles of the invisible GNSS satellites corresponding to the GNSS terminal are smaller than approximately −10 degrees.

4. The GNSS terminal as claimed in claim 1, wherein the aiding data further comprises at lease one of (a) current time, (b) a rough position of the GNSS terminal, and (c) Differential-Global-Positioning-System (DGPS) correction data.

5. The GNSS terminal as claimed in claim 1, wherein the aiding data collector sends the aiding data request when the GNSS terminal restarts, existing aiding data expires, a base station or wireless access point of the GNSS terminal changes, or predetermined timeout for checking whether any invisible GNSS satellites become visible occurs.

6. The GNSS terminal as claimed in claim 1, wherein the aiding data collector queries the GNSS receiver about the aiding data availability and sending the aiding data according to the response from the GNSS receiver.

7. The GNSS terminal as claimed in claim 1, wherein the aiding data request sent by the aiding data collector comprises position information of the GNSS terminal if the position information does not expire.

8. An aiding data collecting method for a Global Navigation Satellite System (GNSS) terminal connected to an aiding data server through a wireless connection, comprising:
querying about the aiding data availability;
checking whether the aiding data is in the GNSS terminal according to the response of the query;
sending an aiding data request to the aiding data server, and parsing aiding data sent by the aiding data server in response to the aiding data request; and
sending the collected aiding data to the GNSS terminal for acquiring and/or tracking satellite signal from at least one GNSS satellite.

9. The aiding data collecting method as claimed in claim 8, wherein the aiding data comprises orbital parameters and health information of a predetermined number of GNSS satellites visible to the GNSS terminal, and the aiding data is sorted according to dilution of precision (DOP) values of the visible GNSS satellites.

10. The aiding data collecting method as claimed in claim 9, wherein the aiding data further comprises a list of GNSS satellites invisible to the GNSS terminal, wherein estimated elevation angles of the invisible GNSS satellites corresponding to the GNSS terminal are smaller than approximately −10 degrees.

11. The aiding data collecting method as claimed in claim 9, wherein the aiding data further comprises at lease one of (a) current time, (b) a rough position of the GNSS terminal, and (c) Differential-Global-Positioning-System (DGPS) correction data.

12. The GNSS terminal as claimed in claim 8, wherein the timing for sending the aiding data request are when the GNSS terminal restarts, existing aiding data expires, a base station or wireless access point of the GNSS terminal changes, or predetermined timeout for checking whether any invisible GNSS satellites become visible occurs.

13. The aiding data collecting method as claimed in claim 8, wherein the aiding data request comprises position information of the GNSS terminal if the position information does not expire.

14. An aiding data system, subordinate to a Global Navigation Satellite System (GNSS), comprising:
an aiding data server, parsing an aiding data request received from a GNSS terminal to generate aiding data comprising orbital parameters and health information of a predetermined number of visible GNSS satellites visible to the GNSS terminal, sorting the aiding data according to dilution of precision (DOP) values of the visible GNSS satellites, and sending the aiding data to the GNSS terminal in response to the aiding data request; and
the GNSS terminal, connected to the aiding data server through a wireless connection, sending the aiding data request to the aiding data server, parsing the aiding data sent by the aiding data server, and tracking GNSS satellites according to the aiding data to generate a position of the GNSS terminal.

15. The aiding data system as claimed in claim 14, wherein the aiding data further comprises a list of invisible GNSS satellites invisible to the GNSS terminal, wherein elevation angles of the invisible GNSS satellites corresponding to the rough position of the GNSS terminal are less than approximately −10 degrees.

16. The aiding data system as claimed in claim 14, wherein the GNSS terminal sends the aiding data request when the GNSS terminal restarts, previous aiding data expires, a base station or wireless access point of the GNSS terminal changes, or predetermined timeout for checking whether any invisible GNSS satellites become visible occurs.

17. The aiding data system as claimed in claim 14, wherein the aiding data server automatically sends aiding data to the GNSS terminal if satellite health changes.

18. The aiding data system as claimed in claim 17, wherein the GNSS terminal records timestamps of received aiding data as a reference to determine whether received aiding data expires, and the GNSS terminal does not send the aiding data request to the aiding data server if received aiding data has not yet expired.

19. The aiding data system as claimed in claim 14, wherein the aiding data server comprises:
a database, storing information about GNSS satellites; and
an aiding data generator, coupled to the database, querying the database to obtain a database content, calculating dilution of precision (DOP) values of a group of selected GNSS satellites visible to the GNSS terminal based on rough position information of the GNSS terminal, and sorting and filtering the database content according to the DOP values to generate the aiding data.

20. The aiding data system as claimed in claim 19, wherein the aiding data server decodes (a) signals of GNSS or Satellite-Based-Augmentation-System (SBAS) satellites, (b) navigation data or correction data of GNSS control segment, SBAS control segment, or International-GNSS-Service (IGS) network, to update the database.
